(19) United States
(12) Patent Application Publication
(10) Pub. No.: US 2026/0327431 A1
(43) Pub. Date: Oct. 22, 2026

(54) PRODUCTION METHOD FOR AMINO ACID-CONTAINING HYDROTALCITE

(71) Applicant: SETOLAS Holdings, Inc., Takamatsu-shi, Kagawa (JP)

(72) Inventor: Hiroyuki SUGIYAMA, Sakaide-shi (JP)

(73) Assignee: SETOLAS Holdings, Inc., Takamatsu-shi, Kagawa (JP)

(21) Appl. No.: 19/110,387

(22) PCT Filed: Sep. 4, 2023
(86) PCT No.: PCT/JP2023/032195

§ 371 Date: Mar. 10, 2025

(30) Foreign Application Priority Data
Sep. 22, 2022 (JP) 2022-151956

(51) Int. Cl. C09C 1/40; C09C 3/08

(52) U.S. Cl. CPC C09C 1/407; C09C 3/08

(57) ABSTRACT

The present invention provides a novel production method which is for amino acid-containing hydrotalcite and by which the amount of an alkaline solution used can be reduced, and amino acid-containing hydrotalcite having stable quality can be obtained even when a reused amino acid aqueous solution is used as a raw material. The present disclosure is a production method for amino acid-containing hydrotalcite. The production method comprises step (A), a solution preparation step, and a generation step. Step (A) is a step for separating a slurry containing first amino acid-containing hydrotalcite and a dissolved amino acid into first amino acid-containing hydrotalcite and a dissolved amino acid-containing solution. The solution preparation step is a step for preparing a slurry solution by mixing a composite metal oxide with an amino acid aqueous solution derived from the dissolved amino acid-containing solution separated from the slurry after step (A). The generation step is a step for generating second amino acid-containing hydrotalcite by heating the slurry solution.

### FIELD

The present invention relates to a method for producing an amino acid-containing hydrotalcite.

### BACKGROUND

Hydrotalcite compounds, including hydrotalcite and calcinated products thereof, exhibit ion exchange capacity and are used for a variety of purposes, such as in combination with resins to reduce resin degradation. Such hydrotalcite compounds are used in known methods that utilize amino acids to further increase the aspect ratio (PTL 1 and NPL 1 ).

Using a conventional method it is possible to obtain an amino acid-containing hydrotalcite, as a complex of a hydrotalcite compound and an amino acid, by heat treatment of a mixture of a hydrotalcite compound and an amino acid aqueous solution.

### CITATION LIST

### Patent Literature

[PTL 1] International Patent Publication No. WO2019/092453

### Non Patent Literature

[NPL 1] NATURE COMMUNICATIONS (2019) 10:2398, High gas barrier coating using non-toxic nanosheet dispersions for flexible food packaging film.

### SUMMARY

### Technical Problem

An amino acid-containing hydrotalcite obtained by heat treatment of a mixture of a hydrotalcite compound and an amino acid aqueous solution can be obtained in the form of a slurry comprising the amino acid-containing hydrotalcite and the dissolved amino acid. In NPL 1, an alkali solution was added to such a slurry to precipitate an amino acid-containing hydrotalcite, thus obtaining the purified amino acid-containing hydrotalcite. However, subsequent use of the amino acid which was used for production of the amino acid-containing hydrotalcite was not investigated.

Incidentally, there is a need for more effective and efficient use of materials in light of recent calls to meet the SDGs (Sustainable Development Goals) adopted by the United Nations. It is still unknown, however, how to actively utilize the amino acid aqueous solution which is obtained after precipitation of an amino acid-containing hydrotalcite.

It is an object of the present invention to provide a novel production method for an amino acid-containing hydrotalcite using an amino acid aqueous solution as the starting material.

### Solution Problem

The present disclosure includes the following aspects.

### (First Disclosure)

The first disclosure is a method for producing an amino acid-containing hydrotalcite. The production method comprises the following step (A), a solution preparation step, and a formation step.

Step (A) is a step in which a slurry comprising a first amino acid-containing hydrotalcite and a dissolved amino acid is separated into the first amino acid-containing hydrotalcite and a solution containing the dissolved amino acid.

The solution preparation step is a step in which after step (A), the amino acid aqueous solution derived from the solution containing the dissolved amino acid which has been separated from the slurry is mixed with a complex metal oxide obtained by calcinating the hydrotalcite compound precursor, to prepare a slurry solution.

The formation step is a step in which the slurry solution is heated to form a second amino acid-containing hydrotalcite.

### (Second Disclosure)

According to the second disclosure, step (A) of the first disclosure comprises adding water to the slurry to separate it into the first amino acid-containing hydrotalcite and a solution containing the dissolved amino acid.

### (Third Disclosure)

According to the third disclosure, step (A) of the first disclosure comprises separating a slurry comprising the first amino acid-containing hydrotalcite and part of the dissolved amino acid, from a solution containing the remainder of the dissolved amino acid, without adding water to the slurry. Water is then added to the slurry comprising the first amino acid-containing hydrotalcite and part of the dissolved amino acid, to separate the first amino acid-containing hydrotalcite from the solution containing the dissolved amino acid.

### (Fourth Disclosure)

According to the fourth disclosure, step (A) of the first disclosure has the following step (a1) and step (a2), with step (a2) being carried out once or several times.

Step (a1) is a step in which a slurry comprising the first amino acid-containing hydrotalcite and part of the dissolved amino acid is separated from a solution containing the remainder of the dissolved amino acid, without adding water to the slurry.

Step (a2) is a step in which, after step (a1), a slurry comprising the first amino acid-containing hydrotalcite and part of the dissolved amino acid is added to water, and the slurry which includes the first amino acid-containing hydrotalcite, and either includes part of the dissolved amino acid or does not include the dissolved amino acid, is separated from the solution containing the remainder of the dissolved amino acid.

### (Fifth Disclosure)

According to the fifth disclosure, any one of the first disclosure to fourth disclosure further has the following solution preparation step and formation step before step (A).

The solution preparation step is a step in which an amino acid aqueous solution and a complex metal oxide obtained by calcinating a hydrotalcite compound precursor are mixed to prepare a slurry solution.

The formation step is a step in which the slurry solution is heated to form the first amino acid-containing hydrotalcite.

### (Sixth Disclosure)

According to the sixth disclosure, any one of the first disclosure to fifth disclosure further has, after step (A), a step (B) in which the amino acids are reduced from the first amino acid-containing hydrotalcite using an alkali solution.

### (Seventh Disclosure)

According to the seventh disclosure, step (B) of the sixth disclosure comprises adding an alkali solution while stirring the first amino acid-containing hydrotalcite.

### (Eighth Disclosure)

According to the eighth disclosure, the amino acid of any one of the first disclosure to seventh disclosure is an amino acid having a solubility of 10 g/ 100 mL H₂O or greater.

### (Ninth Disclosure)

According to the ninth disclosure, the amino acid of any one of the first disclosure to eighth disclosure is a glycine compound.

### (Tenth Disclosure)

According to the tenth disclosure, the hydrotalcite compound contained in the first amino acid-containing hydrotalcite of any one of the first disclosure to ninth disclosure is represented by the following formula (1).

(M²⁺)1−x(M³⁺)x(OH)₂(Aⁿ⁻)X/n·mH₂O . . . (1)

(In formula (1), M²⁺ represents a divalent metal cation. M^{3 +} represents a trivalent metal cation. Aⁿ⁻ represents an n-valent anion. X is a number satisfying the inequality 0.17<X<0.36. The letter n represents an integer of 1 to 6. The letter m satisfies the inequality 0<m<1.80.

### (Eleventh Disclosure)

According to the eleventh disclosure, the amino acid concentration of the slurry of any one of the first disclosure to tenth disclosure is lower than 0.6 mol/L.

### Advantageous Effects of Invention

The present invention can provide a novel method for producing an amino acid-containing hydrotalcite using an amino acid aqueous solution as the starting material.

### BRIEF DESCRIPTION OF DRAWINGS

FIG. 1 is a flow chart illustrating an example of a first embodiment of the invention. The broken line in FIG. 1 encloses the content of claim 1.

FIG. 2 is a flow chart illustrating an example of a second embodiment of the invention.

FIG. 3 is a flow chart illustrating an example of a third embodiment of the invention.

FIG. 4 is a flow chart illustrating an example of a fourth embodiment of the invention.

### DESCRIPTION OF EMBODIMENTS

The method for producing an amino acid-containing hydrotalcite of the invention will now be described in detail by preferred embodiments. Throughout the present specification, the term “amino acid-containing hydrotalcite” means a hydrotalcite compound chemically modified with an amino acid.

### Method for Producing Amino Acid-Containing Hydrotalcite

According to one embodiment of the invention, the method for producing amino acid-containing hydrotalcite comprises the following steps. The production method comprises, first, step (A) in which a slurry comprising a first amino acid-containing hydrotalcite and a dissolved amino acid is separated into the first amino acid-containing hydrotalcite and a solution containing the dissolved amino acid. The production method also comprises, after step (A), a solution preparation step in which the amino acid aqueous solution derived from the solution containing the dissolved amino acid which has been separated from the slurry, is mixed with a complex metal oxide obtained by calcinating a hydrotalcite compound precursor, to prepare a slurry solution. The production method further comprises a formation step in which the slurry solution is heated to form a second amino acid-containing hydrotalcite.

Step (A) in the production method of the embodiment is a step in which a slurry comprising a first amino acid-containing hydrotalcite and a dissolved amino acid is separated into the first amino acid-containing hydrotalcite and a solution containing the dissolved amino acid. The slurry in step (A) is a slurry obtained after the first amino acid-containing hydrotalcite formation step, and it is a slurry comprising the first amino acid-containing hydrotalcite and the dissolved amino acid. Since the slurry has not been washed with an alkali solution after the first amino acid-containing hydrotalcite formation step, the slurry has no additional alkali solution added. Here, “additional alkali solution” is an alkali solution used to remove the amino acids in the slurry. In step (A), the slurry is separated into the first amino acid-containing hydrotalcite and a solution containing the dissolved amino acid.

The first amino acid-containing hydrotalcite formation step is a step in which a slurry solution, obtained by mixing the amino acid aqueous solution and the complex metal oxide obtained by calcinating a hydrotalcite compound precursor, is heated to form the first amino acid-containing hydrotalcite. Throughout the present specification, this formation step may also be referred to as “heating step”. The formation step will be explained in detail below in regard to each step.

It has been necessary to use at least a certain amount of alkali solution to adequately reduce the amino acids in amino acid-containing hydrotalcite, in cases where a large amount of dissolved amino acids are present in the slurry, and this has placed a limit on improvements in resource use efficiency and production cost. The present inventors have found that if, after using an alkali solution to remove amino acids, it is then attempted to reuse the dissolved amino acids obtained by solid-liquid separation as a starting amino acid aqueous solution, the metal ion content of the aqueous solution tends to vary and the amount of amino acids in the slurry is relatively lower than the OH⁻ groups, making it difficult to obtain amino acid-containing hydrotalcite with stable quality.

The present inventors have also found that it is possible to reduce the amount of alkali solution used by employing a method in which the amino acid-containing hydrotalcite and the solution containing the dissolved amino acid are separated without treating the slurry after the heating step with an alkali solution. In this method, the slurry is separated into amino acid-containing hydrotalcite and a solution containing the dissolved amino acid, and afterwards the amino acid-containing hydrotalcite is treated with an alkali solution. The present inventors further found that this method can yield an amino acid-containing hydrotalcite with stable quality even when the reused amino acid solution is used as starting material.

The present invention has been completed based on this finding, and in the production method according to one embodiment of the invention, the slurry obtained from the formation step is separated into a first amino acid-containing hydrotalcite and a solution containing the dissolved amino acid in step (A), without treating it with an alkali solution. In the production method of the embodiment, the separated first amino acid-containing hydrotalcite may be treated with an alkali solution at any time point after step (A). Since almost no dissolved amino acid is present in the separated first amino acid-containing hydrotalcite, it is possible to minimize the amount of alkali solution necessary for alkali treatment. In other words, the production method of the embodiment can reduce the amount of alkali solution used.

Moreover, as mentioned above, the production method of the embodiment includes, after step (A), a step of reutilizing the solution containing the dissolved amino acid separated from the slurry, using it as the starting aqueous solution for production of the next amino acid-containing hydrotalcite. In other words, the production method comprises a solution preparation step in which the amino acid aqueous solution obtained from the separated solution containing the dissolved amino acid is mixed with a complex metal oxide to prepare a slurry solution, and a formation step in which the slurry solution is heated to form the next second amino acid-containing hydrotalcite.

In the production method of the embodiment, the solution containing the dissolved amino acid separated in step (A) is not treated with an alkali solution, and therefore when the solution is reutilized as starting aqueous solution in subsequent production, the metal ion content of the aqueous solution is unlikely to vary and the amount of amino acid ion in the slurry is greater than that of the OH⁻ groups. The production method of the embodiment can therefore yield amino acid-containing hydrotalcite of stable quality even when a reutilized amino acid aqueous solution is used as production starting material. Since the production method of the embodiment is excellent for recycling, it is also advantageous from the standpoint of helping to achieve SDGs (Sustainable Development Goals) adopted by the United Nations.

The phrase “amino acid aqueous solution derived from the solution containing the dissolved amino acid” refers not only to the solution itself which contains the dissolved amino acid, but also to an amino acid aqueous solution with the amino acid concentration adjusted by treatment such as concentration, dilution or adsorption of the solution containing the dissolved amino acid.

In the production method of the embodiment, the slurry before separation in step (A) can be obtained by the same processes as the solution preparation step and formation step described above. That is, the production method of the embodiment may also include a solution preparation step and formation step before step (A). The solution preparation step is a step in which an amino acid aqueous solution and a complex metal oxide obtained by calcinating a hydrotalcite compound precursor are mixed to prepare a slurry solution. The formation step is a step of heating the slurry solution to form a first amino acid-containing hydrotalcite.

If the method further includes a solution preparation step and formation step before step (A), then the production conditions can be adjusted in each step, allowing the slurry to be obtained with the expected first amino acid-containing hydrotalcite and dissolved amino acid in a more precise manner. This allows the effect of the embodiment to be more reliably obtained.

The production method of the embodiment may also include a cooling step in which the slurry is cooled, after the formation step and before step (A). The cooling step will be explained in detail below in regard to each step.

Each step in the method for producing the amino acid-containing hydrotalcite of this embodiment will now be explained in further detail using the first to fourth embodiments for illustration. In the explanation for each step, hydrotalcite will sometimes be abbreviated as “HT”.

### FIRST EMBODIMENT

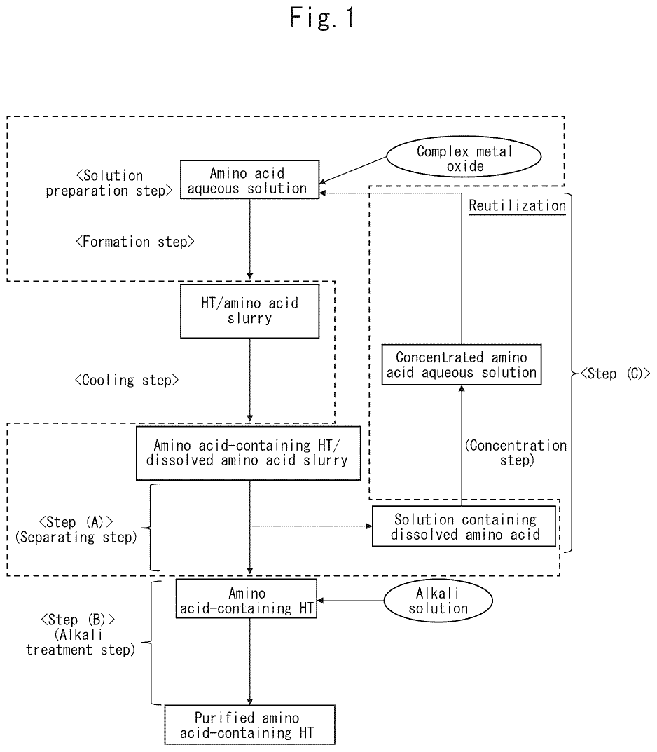

FIG. 1 is a flow chart illustrating an example of a first embodiment of the invention. As shown in FIG. 1, the first embodiment of the invention comprises a solution preparation step, a formation step, a cooling step, step (A) as the separating step, and step (B) as the alkali treatment step. For the first embodiment, a purified first amino acid-containing hydrotalcite (purified amino acid-containing HT) is obtained by the aforementioned steps.

The first embodiment also comprises step (C), after step (A), in which the solution containing the dissolved amino acid as the liquid that has been separated by step (A) is treated so that it can be used as part of the production starting material for the next amino acid-containing hydrotalcite, and is reused.

Step (C) of the first embodiment comprises a step in which the solution containing the dissolved amino acid separated from the slurry in step (A) is treated in a concentration step to obtain a concentrated amino acid aqueous solution. The concentrated amino acid aqueous solution is an example of the “amino acid aqueous solution derived from the solution containing the dissolved amino acid”. The obtained concentrated amino acid aqueous solution is reutilized as part of the production starting material for the next amino acid-containing hydrotalcite (the second amino acid-containing hydrotalcite). That is, the concentrated amino acid aqueous solution is supplied to the solution preparation step during production of the second amino acid-containing hydrotalcite, and is mixed with the complex metal oxide obtained by calcinating a hydrotalcite compound precursor.

According to the first embodiment, any additional steps such as a drying step and surface treatment step may also be carried out for the purified amino acid-containing HT obtained after step (B).

Each step of production method of the first embodiment will now be explained in detail.

### Solution Preparation Step

The solution preparation step is a step in which an amino acid aqueous solution and complex metal oxide obtained by calcinating a hydrotalcite compound precursor, are mixed to prepare a slurry solution. The solution preparation step is a step carried out not only when producing the first amino acid-containing hydrotalcite, but also when producing the next second amino acid-containing hydrotalcite or when producing the subsequent amino acid-containing hydrotalcite. At least part of the amino acid aqueous solution used as starting material is derived from the solution containing the dissolved amino acid which was separated and recovered during production of the previous amino acid-containing hydrotalcite. For example, at least part of the amino acid aqueous solution for production of the second amino acid-containing hydrotalcite is derived from the solution containing the dissolved amino acid which was separated and recovered during production of the previous first amino acid-containing hydrotalcite.

In the solution preparation step, first the hydrotalcite compound precursor is calcinated to obtain a complex metal oxide. The calcinating conditions for calcinating of the hydrotalcite compound precursor are not particularly restricted, and any calcinating conditions suitable for the calcinating means may be employed. When the calcinating uses a kiln, for example, the calcinating temperature may be 300 °C to 800 °C. The calcinating time in this case may be 0.1 hour to 24 hours. When the calcinating uses microwaves, the calcinating temperature may be 300 °C to 800 °C, for example. The calcinating time in this case may be 1 minute to 12 hours.

An amino acid aqueous solution at a prescribed concentration is added to and mixed with the complex metal oxide powder obtained by calcinating of the hydrotalcite compound precursor, to obtain a slurry solution. At least part of the amino acid aqueous solution is derived from the solution containing the dissolved amino acid which was separated and recovered during production of the previous amino acid-containing hydrotalcite, as mentioned above.

In the solution preparation step, the slurry concentration of the slurry solution obtained by mixing the complex metal oxide and the amino acid aqueous solution is preferably lower than 30 g/L. If the slurry concentration is lower than 30 g/L, interaction between the hydrotalcite compound particles will be reduced, helping to limit gelling of the hydrotalcite compound during the delamination process. This will help to maintain the slurry state of the slurry solution, allowing the desired amino acid-containing hydrotalcite to be produced in a more stable manner.

The slurry concentration during the solution preparation step is more preferably in the range of 1 g/L to 28 g/L from the viewpoint of productivity. The slurry concentration can be determined by the following formula.

Slurry concentration (g/L)=Complex metal oxide weight (g)/slurry volume (L)

In the solution preparation step, the complex metal oxide is hydrated using an amino acid aqueous solution that functions as a delamination agent. During hydration, the amino acid molecules in the solution become intercalated as anions between the layers of the hydrotalcite compound. Heating in the subsequent formation step causes delamination between the hydrotalcite layers, forming thin amino acid-containing hydrotalcite. The amino acid-containing hydrotalcite has accelerated particle growth in the widthwise direction. In other words, amino acid-containing hydrotalcite particles with a high aspect ratio are formed.

### (Hydrotalcite Compound)

The hydrotalcite compound precursor to be used for this embodiment is not particularly restricted, and for example, it may be a hydrotalcite compound represented by the following formula (1).

(M²⁺)1−x(M³⁺)x(OH)₂(Aₙ₋)X/n·mH₂O . . . (1)

In formula (1), M-represents a divalent metal cation. M³⁺ represents a trivalent metal cation. Aₙ₋ represents an n-valent anion. X is a number satisfying the inequality 0.17<X<0.36. The letter n represents an integer of 1 to 6. The letter m is a number satisfying the inequality 0<m<1.80.

In formula (1), M²⁺ is preferably Mg²⁺. In formula (1), M³⁺ is preferably A³⁺. These hydrotalcite compounds are advantageous in terms of high safety for the human body. Because these hydrotalcite compounds have refractive indexes similar to those of resins such as polypropylene or polyethylene, they are advantageous for easily maintaining the transparency of compositions with these resins. The molar ratio of Mg/Al₂ is preferably in the range of 4 to 8 from the viewpoint of more reliably obtaining a hydrotalcite structure.

The type of anion for An-in formula (1) is not particularly restricted, and it may be carbonate ion (CO₃²⁻) or hydroxide ion (OH⁻) , for example. Carbonate ion, for example, is preferred from the viewpoint of avoiding generation of corrosive gases such as chlorine gas and nitrogen dioxide gas during calcinating of the hydrotalcite compound precursor.

The hydrotalcite compound is a hydrotalcite compound precursor as the production starting material for the amino acid-containing hydrotalcite, and it is the same as the hydrotalcite compound in the amino acid-containing hydrotalcite obtained as the final product. In other words, the hydrotalcite compound in the amino acid-containing hydrotalcite obtained as the final product may also be a hydrotalcite compound represented by formula (1). The amino acid-containing hydrotalcite obtained as the final product may be the first amino acid-containing hydrotalcite, or it may be the second amino acid-containing hydrotalcite which is produced next, or an amino acid-containing hydrotalcite produced thereafter.

### (Amino Acids)

The amino acids to be used for the embodiment are not particularly restricted and may be any types of amino acids such as α-amino acids, β-amino acids or γ-amino acids, for example. More specific examples include aspartic acid, glutamic acid, asparagine, serine, glycine, β-alanine, β-aminobutyric acid, γ-aminobutyric acid and β-leucine. The amino acids used may be of a single type of amino acid, or two or more types of amino acids in combination.

Preferred among these amino acids are those having solubility of 10 g/ 100 mL H₂O or greater, with glycine compounds being more preferred. Such amino acids, and especially glycine compounds, have high permittivity and therefore tend to yield amino acid-containing hydrotalcite having primary particles of small thickness. Glycine which exhibits bacteriostatic action is used as a supplement, coloring agent and aromatic component, and is advantageous in terms of biostability.

The phrase “solubility of 10 g/ 100 mL H₂O or greater” as used herein means solubility such that the mass of substance dissolving in 100 g of water at 25 °C is 10 g or greater. The substance in this case is an amino acid.

The aforementioned amino acids are for use as production starting material for amino acid-containing hydrotalcite, but the same ones also apply as amino acids in the amino acid-containing hydrotalcite obtained as the final product. In other words, the amino acids in the amino acid-containing hydrotalcite obtained as the final product may also be any of the aforementioned amino acids. However, the amino acids in the amino acid-containing hydrotalcite may also include multimers obtained by bonding of multiple different amino acids which may form during the production process. The “multimers” referred to here are peptides. As used herein, the term “amino acid compound” will be used to refer to substances including the aforementioned amino acids and amino acid multimers. For example, a substance including glycine and polyglycine will be referred to as a “glycine compound”.

The amino acid concentration of the slurry solution in the solution preparation step is not particularly restricted but is preferably lower than 0.6 mol/L. If the amino acid concentration of the slurry solution is within this range it will be easier to obtain amino acid-containing hydrotalcite having an aspect ratio of 85 or higher and resistance to coloration during formation of the resin composition. A resin composition containing the amino acid-containing hydrotalcite is advantageous for allowing formation of a covering layer with a high gas barrier property, and high transparency with low coloration. The amino acid concentration of the slurry solution is more preferably in the range of 0.02 mol/L to 0.5 mol/L.

In the solution preparation step, the molar ratio between the amino acids in the slurry solution and the trivalent metal cation of the hydrotalcite compound (the molar ratio of amino acid/(M³⁺)₂) is preferably in the range of 2 to 6. For example, when the amino acids are glycine and the trivalent metal cation of the hydrotalcite compound is Al³⁺ the molar ratio of glycine/Al₂ is preferably in the range of 2 to 6. If the molar ratio is within this range it will be easier to obtain amino acid-containing hydrotalcite having an aspect ratio of 85 or higher and resistance to coloration during formation of the resin composition. Moreover with a molar ratio within this range, amino acid-containing hydrotalcite having a primary particle thickness of 20 nm or smaller, for example, can be obtained. By adding it to the coating solution together with a polymer and forming the covering layer on a resin substrate, it is possible to exhibit a high gas barrier property due to a labyrinth effect. A resin composition containing the amino acid-containing hydrotalcite is advantageous for allowing formation of a covering layer with a high gas barrier property, and high transparency with low coloration.

### Formation Step

The slurry solution obtained in the solution preparation step is provided for the following formation step. The formation step is a step of heating the slurry solution to form an amino acid-containing hydrotalcite. In the formation step, the slurry solution obtained in the solution preparation step is heated to promote particle growth of the hydrotalcite compound. The amino acid molecules in the solution become intercalated as anions between the layers of the hydrotalcite compound. This results in delamination between the layers of the hydrotalcite compound, and formation of particles of very small thickness. The particles also have accelerated growth in the widthwise direction. As a result, amino acid-containing hydrotalcite which is a complex of a hydrotalcite compound and an amino acid is formed as particles with a high aspect ratio.

Heating in the formation step is preferably carried out while stirring the slurry solution. The stirring means is not particularly restricted, but preferably it allows uniform stirring to be accomplished while maintaining the fluidity of the slurry solution.

The heating temperature in the formation step is not particularly restricted but is preferably a temperature in the range of 20 °C to 250 °C. A more preferred upper limit for the heating temperature is 170 °C, from the viewpoint of helping to inhibit amino acid denaturation. The heating time in the formation step is not particularly restricted, but it is preferably a time in the range of 1 minute to 100 hours. The formation step is preferably carried out in a manner such that the concentration of the slurry solution does not vary. For example, the formation step will sometimes be carried out in a closed system, or will sometimes be carried out in an open system with appropriate addition of evaporated moisture.

### Cooling Step

For this embodiment, the slurry obtained from the formation step is supplied to a cooling step as shown in FIG. 1. The cooling step is a step in which the slurry comprising the amino acid-containing hydrotalcite and the dissolved amino acid obtained in the formation step is cooled for supply to the subsequent solid-liquid separation step, i.e. step (A). The cooling step is therefore carried out after the formation step and before step (A).

In the cooling step, the slurry comprising the amino acid-containing hydrotalcite and the dissolved amino acid may be cooled during the course of transfer from the formation step to step (A). The cooling step may also involve cooling the slurry using an optional cooling device. The cooling step may also be allowing the slurry to cool naturally without using a cooling device.

The cooling temperature in the cooling step is not particularly restricted but is preferably a temperature in the range of 10 °C to 80 °C. A more preferred cooling temperature is around room temperature, from the viewpoint of easier management. The cooling time in the cooling step is not particularly restricted, but it is preferably a time in the range of 1 minute to 48 hours from the viewpoint of productivity.

When the slurry can be directly supplied to the subsequent step (A) after the formation step, the cooling step is not necessary. The tools and devices used in the subsequent separating step may still operate normally, even if the slurry is at high temperature, for example. However, a cooling step is preferably carried out if the tools and devices used in the subsequent separating step do not operate normally when the slurry is at high temperature. Preferred examples in which a cooling step may be carried out include cases of poor heat resistance of the separation film, or malfunctioning of the separation device due to heat.

### Step (A)/Separating Step

The slurry comprising the amino acid-containing hydrotalcite and dissolved amino acid, obtained after the cooling step, is supplied to step (A) which is a solid-liquid separation step. Step (A) is a step of solid-liquid separation of the slurry comprising the amino acid-containing hydrotalcite and the dissolved amino acid, into the amino acid-containing hydrotalcite and a solution containing the dissolved amino acid. The term “separation” as used herein includes the concept of complete separation between the solid portion and the liquid portion, as well as an unavoidable small amount of water in the solid portion.

There are no particular restrictions on the separating means used in the step (A), and for example, it may be membrane separation means, centrifugal separation means, solid-liquid separation means or natural sedimentation means.

Step (A) for this embodiment use the slurry comprising the amino acid-containing hydrotalcite and dissolved amino acid directly, and the slurry may be separated into the amino acid-containing hydrotalcite and the solution containing the dissolved amino acid, although there is no limitation to such like this mode. For example, in step (A), the water may be added to the slurry comprising the amino acid-containing hydrotalcite and the dissolved amino acid, to separate it into the amino acid-containing hydrotalcite and a solution containing the dissolved amino acid. In this case, the slurry may also be separated into the amino acid-containing hydrotalcite and a solution containing the dissolved amino acid after addition of water in step (A). Alternatively, the slurry may be separated into the amino acid-containing hydrotalcite and a solution containing the dissolved amino acid while adding the water in step (A). By thus adjusting the water content of the slurry either before or during separation, it is possible to more precisely separate the slurry into the amino acid-containing hydrotalcite and the solution containing the dissolved amino acid.

During addition of water to the slurry, the total amount of water may be added to the slurry all at once, or a predetermined amount of water may be added in divided portions to the slurry. When the slurry is separated into the amino acid-containing hydrotalcite and the solution containing the dissolved amino acid while adding water, the supply rate of the water may be kept at a fixed amount, or it may be adjusted to a desired variable amount. The water added to the slurry is not particularly restricted and may be ion-exchanged water, for example.

In step (A), the step of separating the slurry comprising the amino acid-containing hydrotalcite and the dissolved amino acid into the amino acid-containing hydrotalcite and the solution containing the dissolved amino acid may be carried out only once, or it may be carried out in several divided parts, such as two or more parts. The mode for step (A) in which the separating step is carried out in several divided parts will be explained below for a different embodiment.

### Step (B)/Alkali Treatment Step

For this embodiment, the amino acid-containing hydrotalcite in the solid portion separated by step (A) is supplied to step (B) which is the alkali treatment step, as shown in FIG. 1. Step (B) is a washing step in which, after step (A), the amount of amino acid in the amino acid-containing hydrotalcite is reduced using an alkali solution. In step (B), amino acids are removed as impurities from the amino acid-containing hydrotalcite, producing a purified amino acid-containing hydrotalcite (purified amino acid-containing HT). The amino acids in the solid portion separated by step (A) are mostly amino acids intercalated between the hydrotalcite layers, and potentially also include amino acids adhering to the hydrotalcite surface.

If the alkali treatment step is carried out before separating the slurry into the amino acid-containing hydrotalcite and the solution containing the dissolved amino acid after the formation step, then a large amount of amino acid will be present in the slurry, requiring a large amount of alkali solution.

According to this embodiment, however, the amino acid-containing hydrotalcite is treated with the alkali solution after the slurry has been separated into the amino acid-containing hydrotalcite and the solution containing the dissolved amino acid after the formation step. Since the separated amino acid-containing hydrotalcite has a low amino acid content, this embodiment allows amino acids in the amino acid-containing hydrotalcite to be reduced with a small amount of alkali solution. In other words, this embodiment can reduce the amount of alkali solution used in the alkali treatment step.

The degree to which the amount of alkali solution used can be reduced depends on the treatment conditions such as the type of alkali solution used and the separating means, and depending on the conditions it may be possible to reduce the amount of alkali solution use by about 60% compared to when the alkali treatment step is carried out before the separating step. For example, when using glycine as an amino acid and sodium hydroxide as an alkali, the total amount of amino acid used is glycine/Al₂=5.26 and the interlayer amino acid in the delaminated HT of glycine/Al₂=2, allowing a reduction in alkali use of [1−( 2/5.26)]×100=62%. This calculation assumes a condition in which all of the interlayer hydrotalcite is filled with glycine and no glycine is adhering to the hydrotalcite surface.

For this embodiment, the type of alkali component in the alkali solution used in step (B) is not particularly restricted, so long as it can reduce the amino acids in the amino acid-containing hydrotalcite. Examples of such alkali components include sodium hydroxide, potassium hydroxide, lithium hydroxide, calcium hydroxide, ammonia and sodium carbonate. Preferred alkali components are sodium hydroxide, potassium hydroxide and ammonia, with sodium hydroxide and potassium hydroxide being more preferred, and sodium hydroxide being even more preferred. These alkali components may be used alone, each as a single type of alkali component, or they may be used in combinations of two or more alkali components.

In step (B), the concentration for treatment of the amino acid-containing hydrotalcite in the alkali solution is not particularly restricted so long as it is a concentration that can reduce the amino acids in the amino acid-containing hydrotalcite, but conditions without a very high concentration are preferred from the viewpoint of inhibiting aggregation. The treatment concentration is the alkali content ratio with respect to the total volume of the mixture of the alkali solution added to the amino acid-containing hydrotalcite, i.e. the slurry.

The concentration of the alkali solution used for alkali treatment is not particularly restricted and may be a concentration in a range that does not cause thickening of the slurry of the alkali solution added to the amino acid-containing hydrotalcite. For example, the upper limit of the alkali solution concentration may be 4.0 mol/L or lower, preferably 3.0 mol/L or lower and even more preferably 2.0 mol/L or lower. The lower limit of the alkali solution concentration may be higher than 0 mol/L, preferably 0.1 mol/L or higher and even more preferably 0.2 mol/L or higher.

For this embodiment, step (B) may be carried out by stirring the slurry of the alkali solution added to the amino acid-containing hydrotalcite. The stirring in step (B) may be initiated after the alkali solution has been added to the amino acid-containing hydrotalcite, or stirring may be carried out while the alkali solution is being added to the amino acid-containing hydrotalcite.

The stirring conditions in step (B) are not particularly restricted, but the stirring speed and stirring power are preferably sufficient to allow stirring of at least the slurry. For example, the stirring speed is preferably adjusted so as to reduce foaming, scattering and gelling, and to produce a uniform slurry solution. When the alkali solution is added, it is preferably adjusted to avoid any local pH imbalance. The stirring speed may be any desired speed suited for the stirring blade, the type of stirrer, the size and shape of the container, the slurry viscosity, the slurry concentration, the alkali solution concentration and the rate at which the alkali solution is added, and it may be, for example, 50 to 2000 rpm, and preferably 100 to 1500 rpm. The temperature during stirring is not particularly restricted and may be room temperature, for example.

When the alkali solution is added to the amino acid-containing hydrotalcite in step (B) of this embodiment, preferably the alkali solution is added while stirring the amino acid-containing hydrotalcite. The stirring is preferably at a level that maintains the slurry state, i.e. that maintains a stirrable state, as the alkali solution is gradually added to the amino acid-containing hydrotalcite. Adding the alkali solution while stirring can inhibit local aggregation of the slurry.

The time and the conditions such as the supply rate, temperature and stirring speed when the alkali solution is added to the amino acid-containing hydrotalcite are preferably adjusted as appropriate for the slurry viscosity, so that the slurry does not become thickened.

### Step (C)/Reutilization Step

According to this embodiment, the solution containing the dissolved amino acid, as the liquid part separated by step (A), is supplied to step (C), which is the reutilization step, as shown in FIG. 1. Step (C) is a step in which the solution containing the dissolved amino acid separated by step (A) is treated to make it usable as part of the production starting material for the amino acid-containing hydrotalcite, and is reused.

In step (C), when the solution containing the dissolved amino acid can be used directly as production starting material for the amino acid-containing hydrotalcite, the solution may be reutilized as is without any particular treatment, but in most cases adjustment of the amino acid concentration of the solution will be necessary.

According to this embodiment, as shown in FIG. 1, step (C) has a concentration step for adjustment of the amino acid concentration of the solution containing the dissolved amino acid that has been separated in step (A). The concentration step for this embodiment is a step in which the amino acid concentration of the aqueous solution is increased by heating and concentrating the solution containing the dissolved amino acid. The concentrated amino acid aqueous solution obtained from the concentration step is reutilized as part of the production starting material for the next amino acid-containing hydrotalcite. For example, the solution containing the dissolved amino acid which was separated and recovered during production of the previous first amino acid-containing hydrotalcite becomes a concentrated amino acid aqueous solution by the concentration step (step (C)), and it is supplied to the solution preparation step during production of the second amino acid-containing hydrotalcite.

The step of adjusting the amino acid concentration of the solution containing the dissolved amino acid is not limited to the aforementioned concentration step by heating and concentration. Other examples of steps for adjusting the amino acid concentration include an amino acid addition step in which an amino acid is added, a dilution step in which ion-exchanged water is added, and an adsorption step in which a complex metal oxide (calcinated HT) is added to adsorb the amino acid. Any of these steps may be employed alone, or several steps may be employed in combination.

Step (C) may also include a pH adjusting step, or a step of adjusting the metal ion amounts of magnesium and aluminum eluted from the hydrotalcite, in addition to the aforementioned step of adjusting the amino acid concentration. Notably, when production of amino acid-containing hydrotalcite is carried out repeatedly, this results in accumulation of metal ions such as magnesium and aluminum in the solution, potentially increasing the effect on the molar ratio of the production starting material. By carrying out a step of adjusting the metal ion amounts in step (C) to reduce the amounts of those metal ions in the solution, it is possible to more precisely produce the amino acid-containing hydrotalcite in a repeated manner. The step of adjusting the metal ion amounts is not particularly restricted, and for example, it may be a step of precipitating and removing the metal ions as hydroxides, or a step of adsorption removal by addition of negatively charged particles.

### Other Treatment Steps

According to the embodiment, optional treatment steps may also be carried out on the purified amino acid-containing HT obtained after step (B). Examples of such treatment steps include a drying step in which the solid portion obtained in step (B) is dried to obtain a powder of the purified amino acid-containing HT, a surface treatment step in which the surfaces of the purified amino acid-containing HT particles are treated with any of various surface treatment agents, and a coating solution preparation step in which a coating solution is prepared by mixing with a polymer solution, without drying the solid portion obtained in step (B).

The production method of the embodiment described above can yield an amino acid-containing hydrotalcite having a high aspect ratio. The amino acid-containing hydrotalcite having such a high aspect ratio will be explained below.

Second to fourth embodiments of the invention, differing from the first embodiment only in steps (A) to (C), will now be described with reference to the accompanying drawings. The steps other than the steps differing from the first embodiment will be omitted from the following explanation, since they are essentially identical to the first embodiment.

### SECOND EMBODIMENT

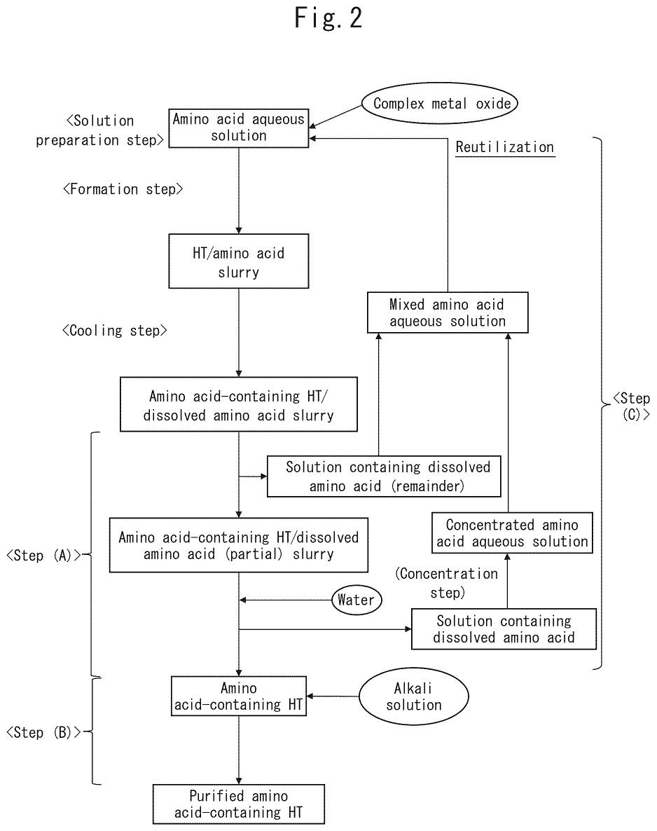

FIG. 2 is a flow chart illustrating an example of a second embodiment of the invention. As shown in FIG. 2, the second embodiment of the invention has, similar to the first embodiment, a solution preparation step, a formation step, a cooling step, step (A) as the separating step, step (B) as the alkali treatment step, and step (C) as the reutilization step.

With the second embodiment, only step (A) and step (C) differ from the first embodiment, while the other steps are the same as the first embodiment.

### Step (A) of Second Embodiment

Step (A) in the second embodiment is a step of solid-liquid separation of the slurry comprising the amino acid-containing hydrotalcite and the dissolved amino acid, into the amino acid-containing hydrotalcite and the solution containing the dissolved amino acid, which is carried out in several divided parts. In the example shown in FIG. 2, the separating step is carried out in two divided parts.

Specifically, in step (A) of the second embodiment, first the slurry comprising the amino acid-containing hydrotalcite and the dissolved amino acid is separated into a slurry comprising the amino acid-containing hydrotalcite and part of the dissolved amino acid, and a solution containing the remainder of the dissolved amino acid, without addition of water. Next, water is added to the slurry comprising the amino acid-containing hydrotalcite and part of the dissolved amino acid, to separate it into the amino acid-containing hydrotalcite and a solution containing the dissolved amino acid.

During addition of water to the slurry, the total amount of water may be added to the slurry all at once, or a predetermined amount of water may be added in divided portions to the slurry. The amino acid-containing hydrotalcite may be separated from the solution containing the dissolved amino acid after adding water to the slurry, or the amino acid-containing hydrotalcite may be separated from the solution containing the dissolved amino acid while adding water to the slurry. When the slurry is separated into the amino acid-containing hydrotalcite and the solution containing the dissolved amino acid while adding water, the supply rate of the water may be kept at a fixed amount, or it may be adjusted to a desired variable amount. The water added to the slurry is not particularly restricted and may be ion-exchanged water, for example.

By carrying out the separating step in several divided parts as in step (A) of the second embodiment, it is possible to reduce the amino acids in the obtained amino acid-containing hydrotalcite. Carrying out the separating step in several divided parts can also increase the reutilization efficiency of the amino acid supplied for reuse. By reducing the amino acid in the obtained amino acid-containing hydrotalcite it is also possible to reduce the amount of alkali solution required for use in the subsequent step (B).

Step (A) of the second embodiment is the same as step (A) of the first embodiment in all aspects other than those explained above.

### Step (C) of Second Embodiment

In the second embodiment, step (C) is a step in which multiple different solutions containing dissolved amino acids, separated and recovered by multiple separating steps in step (A), are treated so that they can be reutilized as part of the production starting material for the next amino acid-containing hydrotalcite, and are reused.

Specifically, in step (C) of the second embodiment, first the solution containing the remainder of the dissolved amino acid separated in the first separating step of step (A) is recovered. Next, the solution containing the dissolved amino acid which was separated in the second separating step of step (A) is recovered, and then heated and concentrated by a concentration step, to obtain a concentrated amino acid aqueous solution with adjusted amino acid concentration. The solution containing the remainder of the dissolved amino acid is then combined with the concentrated amino acid aqueous solution to obtain a mixed amino acid aqueous solution. The obtained mixed amino acid aqueous solution is subsequently reutilized as part of the production starting material for the next amino acid-containing hydrotalcite.

By using multiple different solutions containing dissolved amino acids, separated and recovered by multiple separating steps, as part of the production starting material for the next amino acid-containing hydrotalcite as in step (C) of the second embodiment, it is possible to improve the reutilization efficiency of the amino acids supplied for reutilization. Moreover, by separately treating the multiple different solutions containing dissolved amino acids, separated and recovered by multiple separating steps, depending on the amino acid concentration of each solution, as in step (C) of the second embodiment, it is possible to more precisely produce the next amino acid-containing hydrotalcite.

Incidentally while the concentration step is not always necessary for step (C), if the amino acid concentration of the solution containing the dissolved amino acid is lowered with more separating steps, then it is preferred to carry out a concentration step for the solution containing the dissolved amino acid after the second and later separating steps.

Step (C) of the second embodiment is the same as step (C) of the first embodiment in all aspects other than those explained above.

### THIRD EMBODIMENT

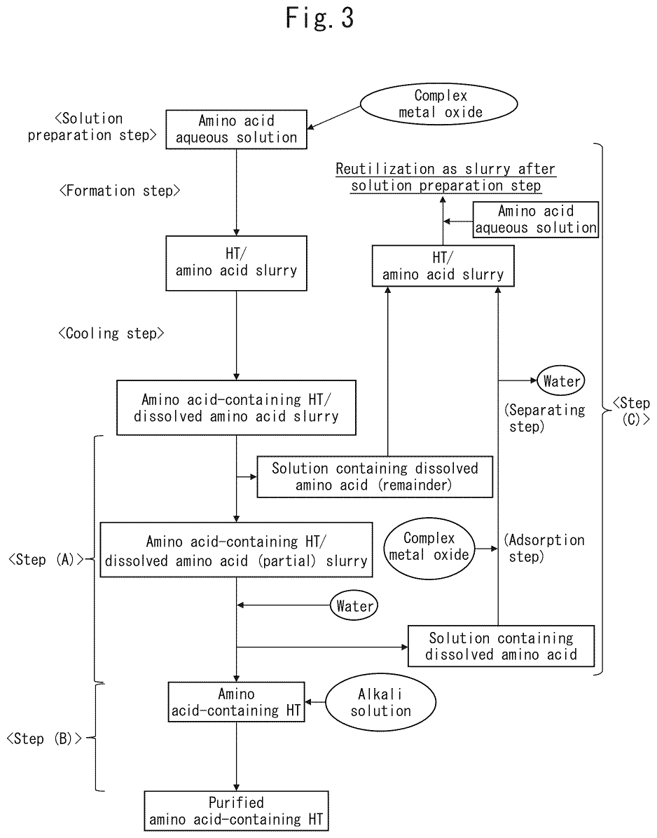

FIG. 3 is a flow chart illustrating an example of a third embodiment of the invention. As shown in FIG. 3, the third embodiment of the invention has, similar to the first embodiment or second embodiment, a solution preparation step, a formation step, a cooling step, step (A) as the separating step, step (B) as the alkali treatment step, and step (C) as the reutilization step.

With the third embodiment, only step (C) differs from the second embodiment, while the other steps are the same as the second embodiment. That is, the steps other than step (A) and step (C) are the same as the first embodiment.

### Step (C) of Third Embodiment

For the third embodiment as well, step (C) is a step in which multiple different solutions containing dissolved amino acids, separated and recovered by multiple separating steps in step (A), are treated so that they can be reutilized as part of the production starting material for the next amino acid-containing hydrotalcite, and are reused. However, step (C) of the third embodiment differs from step (C) of the second embodiment in that after the solution containing the dissolved amino acid separated by the second separating step of step (A) has been recovered, the amino acid concentration is adjusted by the adsorption step and separating step to form the slurry.

Specifically, in step (C) of the third embodiment, first the solution containing the remainder of the dissolved amino acid separated in the first separating step of step (A) is recovered. An adsorption step is then carried out in which the solution containing the dissolved amino acid that has been separated by the second separating step of step (A) is recovered and a complex metal oxide as the calcinated product of the hydrotalcite compound is added to cause adsorption of the amino acid in the solution. This is followed by a separating step in which the slurry after the adsorption step is separated by solid-liquid separation into the solid portion containing the hydrotalcite and amino acid, and water. The previous solution containing the remainder of the dissolved amino acid and the solid portion after the separating step are mixed to obtain a slurry comprising the hydrotalcite and amino acid (HT/amino acid slurry). Fresh amino acid aqueous solution is then added to the obtained HT/amino acid slurry and reutilized as amino acid starting material for the solution preparation step during production of the next amino acid-containing hydrotalcite.

Step (C) of the third embodiment also uses multiple different solutions containing dissolved amino acids, separated and recovered by multiple separating steps, as part of the production starting material for the next amino acid-containing hydrotalcite, making it possible to improve the reutilization efficiency of the amino acids supplied for reutilization. Step (C) of the third embodiment also separately treats the multiple different solutions containing dissolved amino acids, separated and recovered by multiple separating steps, depending on the amino acid concentration of each solution, making it possible to more precisely produce the next amino acid-containing hydrotalcite.

Moreover, as mentioned above, in step (C) of the third embodiment, multiple different solutions containing dissolved amino acids, separated and recovered by multiple separating steps in step (A), are reutilized as amino acid starting material for the solution preparation step during production of the next amino acid-containing hydrotalcite. The third embodiment is therefore advantageous in terms of excellent production efficiency during repeated production of amino acid-containing hydrotalcite.

Step (C) of the third embodiment is the same as step (C) of the first embodiment and second embodiment in all aspects other than those explained above.

### FOURTH EMBODIMENT

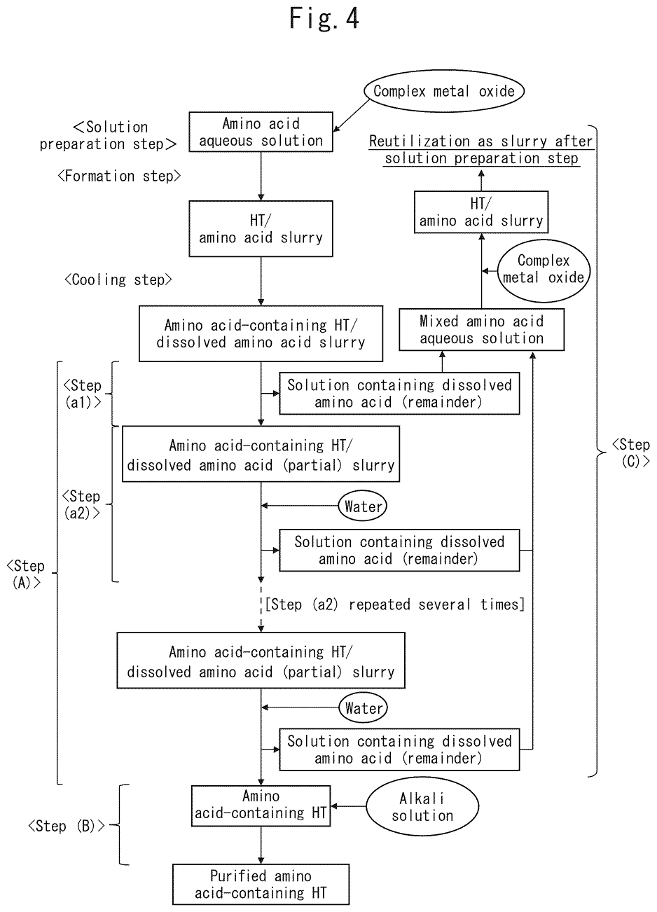

FIG. 4 is a flow chart illustrating an example of a fourth embodiment of the invention. As shown in FIG. 4, the fourth embodiment of the invention also has, similar to the first embodiment, a solution preparation step, a formation step, a cooling step, step (A) as the separating step, step (B) as the alkali treatment step, and step (C) as the reutilization step.

With this embodiment, only step (A) and step (C) differ from the first embodiment, while the other steps are the same as the first embodiment.

### Step (A) of Fourth Embodiment

Step (A) in the fourth embodiment is a step of solid-liquid separation of the slurry comprising the amino acid-containing hydrotalcite and the dissolved amino acid, into the amino acid-containing hydrotalcite and the solution containing the dissolved amino acid, carried out in several divided parts, such as two or more parts.

Specifically, step (A) of the fourth embodiment has the following step (a1) and step (a2), as shown in FIG. 4.

Step (a1) is a step in which the slurry comprising the amino acid-containing hydrotalcite and the dissolved amino acid is separated into a slurry comprising the amino acid-containing hydrotalcite and part of the dissolved amino acid, and a solution containing the remainder of the dissolved amino acid, without addition of water.

Step (a2), after step (a1), is a step in which the slurry comprising the amino acid-containing hydrotalcite and part of the dissolved amino acid is added to water, and the slurry which includes the amino acid-containing hydrotalcite and either includes part of the dissolved amino acid or does not include the dissolved amino acid, is separated from the solution containing the remainder of the dissolved amino acid. Step (a2) is carried out once or several times.

During addition of water to the slurry, the total amount of water may be added to the slurry all at once, or a predetermined amount of water may be added in divided portions to the slurry.

The amino acid-containing hydrotalcite may be separated from the solution containing the dissolved amino acid after adding water to the slurry, or the amino acid-containing hydrotalcite may be separated from the solution containing the dissolved amino acid while adding water to the slurry. When the slurry is separated into the amino acid-containing hydrotalcite and the solution containing the dissolved amino acid while adding water, the supply rate of the water may be kept at a fixed amount, or it may be adjusted to a desired variable amount. The water added to the slurry is not particularly restricted and may be ion-exchanged water, for example.

In step (A) of the fourth embodiment as well, the separating step is carried out in several divided parts, making it possible to reduce the amino acids in the obtained amino acid-containing hydrotalcite. Carrying out the separating step in several divided parts can also increase the reutilization efficiency of the amino acid supplied for reuse. By reducing the amino acid in the obtained amino acid-containing hydrotalcite it is also possible to reduce the amount of alkali solution required for use in the subsequent step (B).

Step (A) of the fourth embodiment is the same as step (A) of the first embodiment and second embodiment in all aspects other than those explained above.

### Step (C) of Fourth Embodiment

For the fourth embodiment as well, step (C) is a step in which multiple different solutions containing dissolved amino acids, separated and recovered by multiple separating steps in step (A), are treated so that they can be reutilized as part of the production starting material for the next amino acid-containing hydrotalcite, and are reused. However, step (C) of the fourth embodiment differs from step (C) of the first to third embodiments in that the solutions containing the dissolved amino acids which have been separated in the divided separating steps of step (A) are combined, and the complex metal oxide is added to the obtained mixed amino acid aqueous solution to form the slurry.

Specifically, in step (C) of the fourth embodiment, the multiple different solutions containing dissolved amino acids separated by the multiple separating steps of step (A), i.e. step (al) and one or more of step (a2), are recovered and combined to obtain a mixed amino acid aqueous solution. Next, the complex metal oxide as the calcinated product of the hydrotalcite compound is added to the mixed amino acid aqueous solution, to obtain a slurry comprising the hydrotalcite and amino acid (HT/amino acid slurry). The HT/amino acid slurry is reutilized as amino acid starting material for the solution preparation step, during production of the next amino acid-containing hydrotalcite.

Step (C) of the fourth embodiment also uses multiple different solutions containing dissolved amino acids, separated and recovered by multiple separating steps, as part of the production starting material for the next amino acid-containing hydrotalcite, making it possible to improve the reutilization efficiency of the amino acids supplied for reutilization. Moreover, as mentioned above, in step (C) of the fourth embodiment, multiple different solutions containing dissolved amino acids, separated and recovered by multiple separating steps in step (A), are reutilized as amino acid starting material for the solution preparation step during production of the next amino acid-containing hydrotalcite. The fourth embodiment is therefore advantageous in terms of excellent production efficiency during repeated production of amino acid-containing hydrotalcite.

Step (C) of the fourth embodiment is the same as step (C) of the first to third embodiments in all aspects other than those explained above.

According to the methods of the embodiments of the invention described above, amino acids are used as delamination agents to produce delamination of the hydrotalcite compound, so that amino acid-containing hydrotalcite can be obtained having small primary particle thicknesses, i.e. a high aspect ratio. Amino acid-containing hydrotalcites obtained by the methods of the aforementioned embodiments will now be described.

### [Amino Acid-Containing Hydrotalcites]

The amino acid-containing hydrotalcites obtained by the methods of the embodiments are amino acid-containing hydrotalcites having high aspect ratios of 85 or higher.

An amino acid-containing hydrotalcite with such a high aspect ratio can be mixed with a polymer such as polyvinyl alcohol to form a coating solution. When the coating solution is coated onto a substrate to form a covering layer, the amino acid-containing hydrotalcite within the covering layer becomes arranged parallel to the in-plane direction of the covering layer, whereby an excellent gas barrier property can be exhibited. Amino acid-containing hydrotalcites obtained by the methods of the embodiments can therefore be used for a variety of different purposes that require a gas barrier property. For example, when a coating solution containing such an amino acid-containing hydrotalcite is applied onto a film, it can impart a high gas barrier property to the film.

For the purpose of the present specification, the aspect ratio of the amino acid-containing hydrotalcite is the ratio of the width (diameter) to thickness of the primary particles of the amino acid-containing hydrotalcite having a layered structure. The aspect ratio can be calculated by dividing the width of the primary particles of the amino acid-containing hydrotalcite by their thickness.

The coating solution comprising the amino acid-containing hydrotalcite and the polymer may also comprise other added components. Such added components are not particularly restricted, and examples include antioxidants, reinforcing agents, ultraviolet absorbers, pigments, crosslinking agents and flame retardants. Incidentally, any of these added components may be used as single types alone, or two or more different added components may be used in combination.

A film using the amino acid-containing hydrotalcite can be applied in a wide range of fields including as a food packaging film, beverage packaging film, beverage bottle, drug packaging film, industrial gas barrier film, gas separation film or paper barrier material.

The production process of the invention is not restricted to the embodiments described above or the Examples described below, and can incorporate appropriate combinations, substitutions and modifications within a range that is not outside of the object and gist of the invention.

### EXAMPLES

The invention will now be explained in greater detail using Examples and Comparative Examples, with the understanding that the invention is not limited only to the Examples.

### Example 1

### (Production of Hydrotalcite Compound Precursor)

Ion-exchanged water was loaded into a 1 L volume reaction tank. In the reaction tank there were simultaneously added dropwise 160 mL of a 1.5 mol/L magnesium chloride aqueous solution, 120 mL of a 1 mol/L aluminum chloride aqueous solution and a mixture of 90 mL of an 8 mol/L sodium hydroxide aqueous solution with 60 mL of a 1 mol/L sodium carbonate aqueous solution, while stirring, to obtain a reaction product. The pH during the reaction was 9.5. The reaction product was washed with water. Ion-exchanged water was then added to the reaction product obtain 700 mL of a re-emulsified slurry. The re-emulsified slurry was subjected to hydrothermal treatment for 13 hours at 170 °C. The resulting solid was washed with water. The washed solid was dried at 105 °C for 16 hours. The dried solid was then pulverized. The obtained powder was a hydrotalcite compound represented by the chemical formula Mg_{0.67}Al_{0.33}(OH)₂(CO₃)_{0.17}·0.50H₂O. The hydrotalcite compound was used as a hydrotalcite compound precursor for production of an amino acid-containing hydrotalcite.

### (Calcinating of Hydrotalcite Compound Precursor)

The obtained hydrotalcite compound precursor was calcinated in an electric furnace for 12 hours at 450 °C to obtain a calcinated product (complex metal oxide).

### (Solution Preparation Step 1)

A 14.0 g portion of the obtained calcinated product was loaded into a glass beaker. To this glass beaker there was then added 140 mL of a 2 mol/L aqueous solution of glycine (corresponding to 21.0 g of glycine powder). The slurry solution in the glass beaker was stirred to homogeneity. The glycine/Al₂ molar ratio of the obtained slurry solution was 5.26. Ion-exchanged water was then added to the slurry solution to a total volume of 700 mL. The slurry solution was again further stirred to homogeneity. The slurry concentration was 20 g/L. The glycine concentration was 0.4 mol/L.

### (Formation Step 1)

The slurry solution was subsequently stirred at 700 rpm while conducting hydrothermal treatment for 48 hours at 100 °C. The obtained slurry solution was in a slurry form. The obtained slurry solution also exhibited a white color. The slurry solution did not produce any particular noticeable odor.

### (Step (A)/Separating Step)

Ion-exchanged water was then added to 650 mL of the obtained slurry solution to a total volume of 1300 mL. The slurry concentration was 10 g/L. A stirrer was used to stir the slurry solution at 400 rpm, ordinary temperature for 16 hours. The stirred slurry was subjected to solid-liquid separation. The solution obtained after solid-liquid separation contained the dissolved glycine compound. The glycine compound concentration of the solution was 0.143 mol/L. The solution pH was 8.9.

### (Solution Preparation Step 2)

A 0.143 g portion of the calcinated product obtained in “Calcinating of hydrotalcite compound precursor” above was loaded into a fluorine resin container. A 20 mL portion of the 0.143 mol/L solution comprising the dissolved glycine compound was added to the fluorine resin container. The slurry solution in the fluorine resin container was stirred to homogeneity. The glycine compound/Al₂ molar ratio of the obtained slurry solution was 5.26. The slurry concentration was 7.15 g/L.

### (Formation Step 2)

The fluorine resin container was sealed. The slurry solution in the sealed fluorine resin container was heat treated for 48 hours at 100 °C, without stirring. The obtained slurry solution was in a slurry form. The obtained slurry solution also exhibited a white color.

### (Step (B)/Alkali Treatment Step)

The obtained slurry solution was stirred for 16 hours at ordinary temperature. While continuing to stir the slurry solution, a 4.00 mol/L aqueous sodium hydroxide solution was gradually added dropwise to the slurry solution, in equal volume to the glycine compound. The obtained slurry solution was subjected to solid-liquid separation to obtain an amino acid-containing hydrotalcite for Example 1.

The aspect ratio of the obtained primary particles of the amino acid-containing hydrotalcite of Example 1 was 93. The thickness of the obtained primary particles of the amino acid-containing hydrotalcite of Example 1 was 3.0 nm.

### Comparative Example 1

An amino acid-containing hydrotalcite for Comparative Example 1 was obtained in the same manner as Example 1, except that in “Solution preparation step 1” above, the amount of calcinated product was 17.5 g, the amount of the 2 mol/L aqueous glycine solution was 175 ml (corresponding to 26.3 g of glycine powder), the 4.00 mol/L aqueous sodium hydroxide solution was added dropwise to the slurry solution in equal volume to the glycine compound before “Step (A)/separating step”, the glycine compound concentration was 0.158 mol/L and the pH was 12.4, the amount of calcinated product used in “Solution preparation step 2” above was 0.158 g, and the slurry concentration was 7.90 g/L.

The aspect ratio of the obtained primary particles of the amino acid-containing hydrotalcite of Comparative Example 1 was 14. The thickness of the obtained primary particles of the amino acid-containing hydrotalcite of Comparative Example 1 was 18 nm.

As explained above, in the method of Example 1 wherein the slurry solution was treated with an alkali solution after Step (A)/separating step, an amino acid-containing hydrotalcite was obtained with more stable quality compared to Comparative Example 1 wherein the slurry solution was treated with an alkali solution before step (A)/separating step, even when the amino acid aqueous solution was reused as starting material.

### Industrial Applicability

The method for producing amino acid-containing hydrotalcite of the present invention can be suitably used for production of amino acid-containing hydrotalcite with application for products in a wide range of fields including the fields of food packaging films, beverage packaging films, beverage bottles, drug packaging films, industrial gas barrier films, gas separation films, paper barrier materials, coating materials, scratch resistant materials, cosmetic products and additives.

1. A method of producing an amino acid-containing hydrotalcite, the method comprising:
step (A), in which a slurry comprising a first amino acid-containing hydrotalcite and a dissolved amino acid is separated into the first amino acid-containing hydrotalcite and a solution containing the dissolved amino acid,
a solution preparation step, after step (A), in which an amino acid aqueous solution derived from the solution containing the dissolved amino acid separated from the slurry, is mixed with a complex metal oxide obtained by calcinating a hydrotalcite compound precursor, to prepare a slurry solution, and
a formation step in which the slurry solution is heated to form a second amino acid-containing hydrotalcite.

2. The method according to claim 1, wherein in step (A), water is added to the slurry to separate the slurry into the first amino acid-containing hydrotalcite and a solution containing the dissolved amino acid.

3. The method according to claim 1, wherein in step (A):
after separation into a slurry comprising the first amino acid-containing hydrotalcite and part of the dissolved amino acid, and a solution containing a remainder of the dissolved amino acid, without adding water to the slurry,
water is then added to the slurry comprising the first amino acid-containing hydrotalcite and part of the dissolved amino acid, to separate the slurry into the first amino acid-containing hydrotalcite and a solution containing the dissolved amino acid.

4. The method according to claim 1, wherein step (A) has:
step (a1) which is separation into a slurry comprising the first amino acid-containing hydrotalcite and part of the dissolved amino acid, and a solution containing a remainder of the dissolved amino acid, without adding water to the slurry, and
step (a2), after step (a1), which is addition of water to the slurry comprising the first amino acid-containing hydrotalcite and part of the dissolved amino acid, to separate the slurry into a slurry comprising the first amino acid-containing hydrotalcite and part of the dissolved amino acid, or containing no dissolved amino acid, and a solution containing a remainder of the dissolved amino acid,
wherein step (a2) is carried out one or several times.

5. The method according to claim 1, which further has, before step (A),
a solution preparation step in which an amino acid aqueous solution and a complex metal oxide obtained by calcinating a hydrotalcite compound precursor are mixed to prepare a slurry solution, and
a formation step in which the slurry solution is heated to form the first amino acid-containing hydrotalcite.

6. The method according to claim 1, which further has, after step (A), a step (B) in which an amount of amino acid in the first amino acid-containing hydrotalcite is reduced using an alkali solution.

7. The method according to claim 6, wherein in step (B), the alkali solution is added while stirring the first amino acid-containing hydrotalcite.

8. The method according to claim 1, wherein the amino acid is an amino acid having a solubility of 10 g/100 mL·H₂O or greater.

9. The method according to claim 1, wherein the amino acid is a glycine compound.

10. The method according to claim 1, wherein a hydrotalcite compound contained in the first amino acid-containing hydrotalcite is represented by a following formula (1),
(M²⁺)₁₋ₓ(M³⁺)x(OH)₂(Aⁿ⁻)X/n·mH₂O . . . (1)
(In formula (1), M²⁺ represents a divalent metal cation, M³⁺ represents a trivalent metal cation, Aⁿ⁻ represents an n-valent anion, X represents a number satisfying 0.17<X<0.36, n is an integer of 1 to 6, and m represents a number satisfying 0<m<1.80.)

11. The method according to claim 1, wherein an amino acid concentration of the slurry is lower than 0.6 mol/L.
